(19) United States
(12) Patent Application Publication
(10) Pub. No.: US 2009/0178091 A1
(43) Pub. Date: Jul. 9, 2009

(54) CONTENTS DISTRIBUTION METHOD AND RECEIVING DEVICE

(76) Inventors: Hiroki MIYAMOTO, Fujisawa (JP); Hideki Kamimaki, Fujisawa (JP); Akira Date, Kunitachi (JP); Nobuhiro Sekimoto, Tachikawa (JP)

Correspondence Address: BRUNDIDGE & STANGER, P.C., 1700 DIAGONAL ROAD, SUITE 330, ALEXANDRIA, VA, 22314, US

(21) Appl. No.: 12/348,084

(22) Filed: Jan. 2, 2009

(30) Foreign Application Priority Data
Jan. 8, 2008 (JP) 2008-000877
Nov. 13, 2008 (JP) 2008-290477

(51) Int. Cl. H04N 7/173

(52) U.S. Cl. 725/91; 725/87

(57) ABSTRACT

The playback of contents in the course of progressive download is stopped depending on the information of the contents and network environments. Also, contents in the course of the playback of progressive download cannot be fast forwarded. When progressive download is indicated, a contents receiving terminal dynamically allocates resources (bus band, CPU, etc.) used in other stream processing within the receiving terminal and fast downloads a portion not downloaded to avoid the interruption of playing contents. Furthermore, the receiving terminal transmits a required communication band to a home gateway, which performs band control with other communications within a home network to allocate a maximum allocatable communication band to the contents receiving terminal.

### CLAIM OF PRIORITY

The present application claims priority from Japanese patent application JP 2008-000877 filed on Jan. 8, 2008, and JP2008-290477 filed on Nov. 13, 2008, the contents of which are hereby incorporated by reference into this application.

### FIELD OF THE INVENTION

The technical field of this invention relates to a contents distribution method through a network, and a contents receiving device.

### BACKGROUND OF THE INVENTION

In recent years, as network lines and hard disk become larger in capacity, IP television (IPTV) services that distribute contents such as television programs and movies through an IP (Internet Protocol) network are being realized. VOD services such as streaming service that enables viewing on demand, and download service that enables high-quality video to be viewed are becoming available on television to meet users' needs. The download service can provide service which automatically downloads users' favorite commercial contents to a television or recorder equipped with HDD, in addition to service which allows users to explicitly download contents. Thus, the video download service having wide uses will be used more frequently, and off-premise communication rates may increase. Therefore, an efficient download control method is an important problem.

In JP-A-2002-290948, a playback control method of download service is studied.

For the problem that “the progress of download, video playing position, and disk capacity can be checked, and the timing of playing video contents can be freely selected,” a solution to it is described as “when contents are requested from a transmission part 111 to a video server, the contents are transmitted from the video server, and a receiving part 112 acquires contents size. The receiving part 112 compares the contents size and disk capacity, and if the disk capacity is insufficient, displays shortage of disk capacity in a display part 117. If the disk capacity is not insufficient, the receiving part 112 acquires the contents, a writing part 113 writes the contents to disk 114, and the display part 117 displays download progress. When the contents have become ready for playback, information indicating that playback is possible is displayed in the display part 117. When the user executes playback, a reading part 115 reads the contents from the disk 114, and a play part 116 displays a playing position in the display part 117.”

### SUMMARY OF THE INVENTION

Viewing forms of IP broadcast programs fall into three major categories: streaming viewing that performs viewing in real-time; download viewing that performs viewing after download; and progressive download viewing that performs playback while performing download, in combination of the two.

In JP-A-2002-290948, a technical idea of progressive download is disclosed; that is, download progress in the course of progressive download is displayed, and when contents have become ready for playback, information indicating that playback is possible is displayed in a display part.

However, the above-described JP-A-2002-290948 has a problem that a specific means for determining whether contents have become ready for playback is not shown, and particularly it is not considered that viewing-ready timing depends on the information of the contents and network environments.

In one embodiment of the present invention, a terminal transmits a request to start playing of downloaded contents to a home gateway between the terminal and a server or a broadband router, according to the transmitted request, the home gateway controls a transmission band between the server and terminal, and the terminal secures resources necessary for the download, changes execution speed of the download, and plays the contents.

Also, in one embodiment of the present invention, a terminal transmits a request to start playing of downloaded contents to a server, controls a transmission band between the server and the terminal according to the transmitted request, secures resources necessary for the download, changes execution speed of the download, and plays the contents.

According to the above-described means, the contents delivery method and contents receiving device that accepted the use case of the user can be provided. For example, IP broadcast programs matching the information of contents and network environments can be viewed.

### BRIEF DESCRIPTION OF THE DRAWINGS

FIG. 1 shows an example of a system configuration;

FIG. 2 shows an example of a program recording and playback device of a first embodiment;

FIG. 3 shows an example of a home gateway of a first embodiment;

FIG. 4 shows an example of a band securing request;

FIG. 5 shows an example of a flowchart showing an overall flow of progressive download of a first embodiment;

FIG. 6 shows an example of a flowchart of band control processing;

FIG. 7 shows an example of a flowchart of resource allocation processing;

FIG. 8 shows the influence of a receiver in transfer rate control;

FIG. 9 shows an example of system configuration of a second embodiment;

FIG. 10 shows an example of a program recording and playback device of a second embodiment;

FIG. 11 shows an example of a band control table of a second embodiment; and

FIG. 12 shows an example of a flowchart showing an overall flow of progressive download of a second embodiment.

### DETAILED DESCRIPTION OF THE PREFERRED EMBODIMENTS

Hereinafter, preferred embodiments of the present invention will be described with reference to the accompanying drawings. However, the application of the present invention is not limited to the embodiments.

### First Embodiment

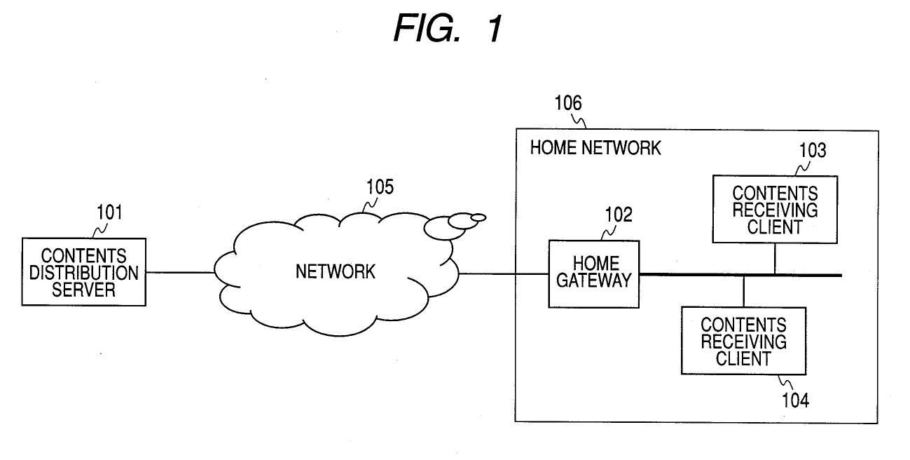

First, system configuration will be described. FIG. 1 shows an example of a system configuration of the present invention.

In the drawing, the reference numeral 101 designates a contents distribution server; 102, a home gateway; 103, a contents receiving client 1; 104, a contents receiving client 2; 105, a network; and 106, a home network.

The contents distribution server 101, which is connected with the network 105, stores contents such as videos, and distributes contents according to requests from clients connected via the network.

The home gateway 102, which is generally located in the boundary between a home network having functions equivalent to those of a broadband router, and an external network (the Internet, etc.), has various functions, basically gateway functions such as on-premise and off-premise protocols, and connection conversion. It is connected with the network 105, the contents receiving client 103, and the contents receiving client 104.

The contents receiving clients 103 and 104, which are connected with the home gateway 102, are information processing devices that can store contents transmitted from the contents distribution server via the network in a data storage part of the contents receiving clients to play them.

The network 105, which is a broadband network such as the Internet and CDN (Content Delivery Network), is connected with the contents distribution server 101 and the home gateway 102.

The home network 106, which is an on-premise network in which devices in a house are connected by a wireless LAN, wired LAN, router, and HUB, includes the home gateway 102, the contents receiving client 103, and the contents receiving client 104.

In the system configured as described above, which is a contents download distribution system that downloads contents, the contents receiving clients 103 and 104 transmit a request to download contents to the contents distribution server 101 by use of a network protocol such as HTTP, and receive contents distributed via the network and record them in a storage part of the contents receiving clients. During contents downloading, the contents receiving clients 103 and 104 can play the contents even in the middle of the downloading without break to their end by issuing a request to secure a network band to the home gateway.

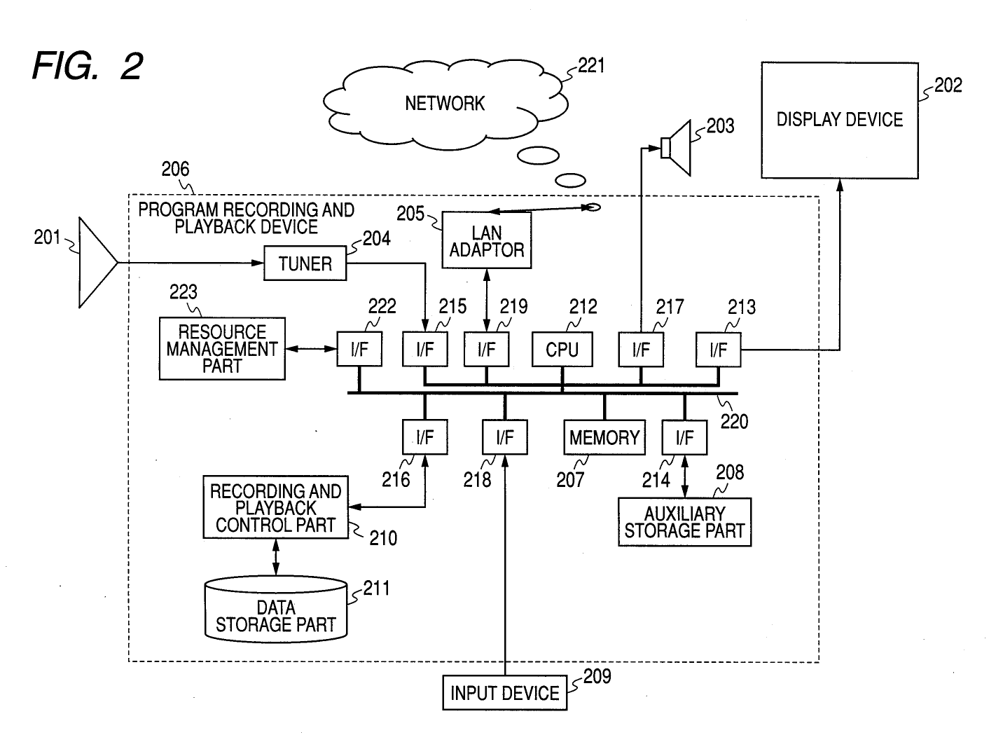

The following describes the contents receiving clients in the system configuration of FIG. 1. FIG. 2 shows an example of a program recording and playback device of the present invention, which corresponds to the contents receiving clients 103 and 104 of FIG. 1.

In this drawing, the reference numeral 201 designates an antenna; 202, a display device; 203, a loudspeaker; 204, a tuner; 205, a LAN adaptor; 206, a program recording and playback device; 207, memory; 208, an auxiliary storage part; 209, an input device; 210, a recording and playback control part; 211, a data storage part; 212, CPU; 213, I/F; 214, I/F; 215, I/F; 216, I/F; 217, I/F; 218, I/F; 219, I/F; 220, bus; 221, network; 222, I/F; and 223, a resource management part.

The antenna 201 is a device for receiving TV broadcasts such as terrestrial analog broadcasts, terrestrial digital broadcast, or BS/CS digital broadcasts, and is connected with the tuner 204.

The display device 202 is a device that can output data streams inputted through an interface as video, and is connected with the I/F 213.

The loudspeaker 203 is a device that can output voice information specified by a program as voice information, and is connected with the I/F 217.

The tuner 204 is a device that selects a channel from a broadcast signal received in the antenna, and is connected with the I/F 215 and the antennal 201.

The LAN adaptor 205 is a device that allows data transmission to and reception from other devices by use of LAN (Local Area Network), and is connected with the network 221 and the interface 219.

The program recording and playback device 206 includes the tuner 204, LAN adaptor 205, memory 207, auxiliary storage part 208, recording and playback control part 210, data storage part 211, CPU 212, I/F 213, I/F 214, I/F 215, I/F 216, I/F 217, I/F 218, I/F 219, bus 220, and I/F 222, and resource management part 223.

The memory 207 is, for example, RAM (Random Access Memory), which is a semiconductor to temporarily record programs and data. It is connected with the CPU 21 and the I/F 222.

The auxiliary storage part 208 is a storage part for storing programs executed by the CPU, and is a nonvolatile storage medium such as ROM (Read Only Memory), SD card, compact flash (registered trademark), and HDD (Hard Disk Drive). It is connected with the I/F 214.

The input device 209, which is connected with the I/F 218, converts a user operation for controlling the program recording and playback device to an electrical signal, and transmits it to the program recording and playback device.

The recording and playback control part 210 is an LSI that can control plural contents data transmitted from the tuner and the LAN adaptor, and contents data outputted to the display and the loudspeaker. It is connected with the data storage part 211 and the I/F 216.

The data storage part 211 is a storage device such as IC memory or HDD (Hard Disk Drive) in which contents data acquired from the tuner and the network can be stored. It is connected with the recording and playback control part 210. The data storage part 211 may be incorporated in the program recording and playback device, or may be a removable media.

The CPU 212, which is a central processing unit for executing a program expanded in the memory, is connected with the memory 207, I/F 213, I/F 217, I/F 214, I/F 219, I/F 215, I/F 216, and I/F 218.

The I/F 213 is an interface through which the display device can be controlled through the bus from other devices.

The I/F 214 is an interface through which the auxiliary storage part can be controlled through the bus from other devices.

The I/F 215 is an interface through which the tuner can be controlled through the bus from other devices.

The I/F 216 is an interface through which the recording and playback control part can be controlled through the bus from other devices.

The I/F 217 is an interface through which the loudspeaker can be controlled through the bus from other devices.

The I/F 218 is an interface through which an electrical signal transmitted from the input device can be received and transmitted to other devices through the bus.

The I/F 219 is an interface through which the LAN adaptor can be controlled through the bus from other devices.

The bus 220 is a communication path through which each device is connected via each interface to enable data transmission and reception.

The network 221 is a broadband network such as the Internet and CDN (Content Delivery Network), and is connected with the LAN adaptor 205.

The I/F 222 is an interface through which the resource management part can be controlled through the bus from other devices.

The resource management part 223 is an LSI or program that monitors bus capacity, CPU use rate, and memory capacity to determine whether broadcast recording, contents playback, VOD, and stream processing such as download recording can be performed. It is connected with the I/F 222.

When contents are downloaded, if user's desired contents are selected by remote controller operation or the like through a user interface shown in the display device 202, the CPU 212 acquires a metafile necessary for downloading from a server on the network via the LAN adaptor 205. The metafile contains information of contents shown to the user as a menu screen in URI of the contents and during downloading.

When starting downloading, the CPU 212 inquires of the recording and playback control part 210 whether there is a sufficient storage capacity. When a capacity necessary for contents downloading has been obtained, the CPU 212 gets a resource use approval from the source management part 223. The resource management part 223 manages the CPU and the bus within the terminal, and determines whether streams can be newly received. When reception is determined as possible in the resource management part 223, the CPU 212 starts downloading through the LAN adaptor 205 and the network 221, and receives contents to their end before terminating the downloading as long as a halt request is not issued from the resource management part 223. Streams during the downloading are stored in the data storage part 211 via the LAN adaptor 205 and the bus 220.

When stream processing other than download is performed, the CPU 212 inquires of the resource management part 223 whether there are sufficient resources. The resource management part 223, in which priorities of individual stream processings are defined, when resources are in shortage, temporarily stops stream processings of lower priority or lowers throughput. The priorities may be determined by services used by the program recording and playback device. Although usually download may be set to a low priority and streaming to a high priority, arbitrary setting is permitted.

When contents being downloaded are played, a download speed must be set to be the same as a playing speed or faster so that a playing position does not overtake a download completion position. In the program recording and playback device 206, when playing contents being downloaded, the resource management part 223 controls a communication band so that a playing position does not overtake a download completion position, for example, by raising the priority of download processing to widen a communication band usable in the download. When plural download processings are being performed, it is desirable that the bus band of contents being downloaded that have been subjected to playback processing, and a CPU occupation ratio are raised as priority.

Since communication of equipment on the home network with an off-premise distribution server or the like is made via the home gateway, it is desirable to secure a communication band within the home network by issuing a band securing request from the LAN adaptor 205 to the home gateway 102 to widen the communication band. Therefore, alternatively, when the use band of streams received in the program recording and playback device 206 changes, the use band may be changed after inquiring of the home gateway 102 by the band securement request whether the change can be accommodated within communication throughput permitted by the home network.

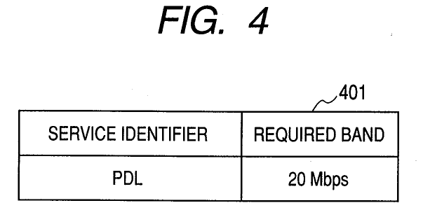

FIG. 4 shows an example of a band securing request transmitted from the program recording and playback device 206 to the home gateway. The band securing request contains a service identifier indicating a desired service and a desired band indicating a band used for the service.

As described above, when a request to change a communication band is made, for example, by performing playback processing for contents being downloaded using an off-premise network, the program recording and playback device of the home network transmits a band securing request containing a service identifier of “PDL” indicating the progressive download of FIG. 4 and a use band of “20 Mbps” for it to the home gateway. On receiving the band securing request, the home gateway, like the resource management part 223, may determine the priority of a stream to be transferred, from a service used by the program recording and playback device, that is, a service indicated by the service identifier of the band securing request. Although usually download is set to a low priority and streaming to a high priority, the priority may be arbitrarily set; for example, progressive download may be set to a high priority.

When service is download, even when the band capacity of the transmitted band securing request is not secured, downloading may be performed with a band capacity smaller than the band capacity of the transmitted band securing request. For example, when the total of capacities of use bands used exceeds the band capacity of the home network, if a high priority is given to streaming, since control is performed so that the band used in the streaming is subtracted from the band capacity of the entire home network to use the remaining bands in the download, although the band capacity of the transmitted band securing request is not secured, even in the case, the downloading may be performed with a band capacity smaller than the band capacity of the band securing request.

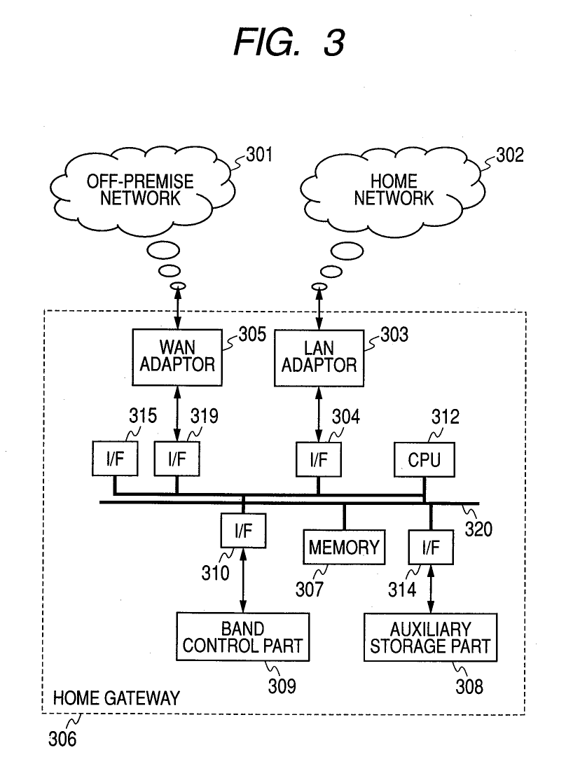

The following describes the home gateway in the system configuration of FIG. 1. FIG. 3 shows an example of a home gateway in the present invention, which corresponds to the home gateway 102 of FIG. 1. It has a NAT (Network Address Translator) function to connect WAN and LAN to perform communication control within the home network 302.

In this drawing, the reference numeral designates an off-premise network; 302, home network; 303, LAN adaptor; 304, I/F; 305, WAN adaptor; 306, home gateway; 307, memory; 308, auxiliary storage part; 309, band control part; 310, I/F; 312, CPU; 314, I/F; 315, I/F; 319, I/F; and 320, bus.

The off-premise network is a broadband network such as the Internet and CDN (Content Delivery Network), and is connected with the WAN adaptor 305.

The home network 302 is a network in which on-premise devices are connected by a wireless LAN, wired LAN, router, and HUB, and is connected with the LAN adaptor 303.

The LAN adaptor 303 is a device that allows data transmission and reception to and from other devices by use of LAN (Local Area Network), and is connected with the home network 302 and the I/F 304.

The I/F 304 is an interface through which the LAN adaptor can be controlled through the bus from other devices.

The WAN adaptor 305 is a device that allows data transmission and reception to and from other devices by use of WAN (Wide Area Network), and is connected with an off-premise network 301 and I/F 319.

The home gateway 306, which is located in the boundary between a home network, and an external network (the Internet, etc.), has various functions based on gateway functions such as on-premise and off-premise protocols, and connection conversion. It includes LAN adaptor 303, I/F 304, WAN adaptor 305, memory 307, auxiliary storage part 308, band control part 309, I/F 310, CPU 312, I/F 314, I/F 315, I/F 319, and bus 320.

The memory 307 is RAM (Random Access Memory) that temporarily records programs and data, and is connected with the CPU 312.

The auxiliary storage part 308, which is a storage part for storing programs executed in the CPU, is a nonvolatile storage media such as ROM (Read Only Memory), SD card, compact flash (registered trademark), and HDD (Hard Disk Drive). It is connected with the I/F 314.

The band control part 309 is an LSI and a program that perform band control to enable fast program data reception when distributing several program data to plural program recording and playback devices. It is connected with the I/F 310.

The I/F 310 is an interface through which the LAN adaptor can be controlled through the bus from other devices.

The CPU 312, which is a central processing unit for executing a program expanded in the memory, is connected with the memory 307, I/F 314, I/F 319, I/F 315, I/F 304, and I/F 310.

The I/F 314 is an interface through which the auxiliary storage part can be controlled through the bus from other devices.

The I/F 315 is an interface through which the tuner can be controlled through the bus from other devices.

The I/F 319 is an interface through which the WAN adaptor can be controlled through the bus from other devices.

The bus 320 is a communication path through which each device is connected via each interface to enable data transmission and reception.

The home gateway 306 generally uses an off-premise network and an on-premise network (home network) and has a firewall function, a protocol conversion function, and other functions. The following describes a method of band control for a band securing request from the program recording and playback device.

On receiving data transmitted the via home network from the program recording and playback device, the home gateway expands the received data in the memory 307 via the LAN adaptor 303. Before acquiring contents requested from the program recording and playback device from the server, the home gateway determines whether streams of the contents requested in the home network 302 can be transmitted. When there is a session that receives streams from the off-premise network 302 via the home gateway, the home gateway checks service of stream processing to limit the use band of the relevant session. The service referred to here is streaming, download, or progressive download, and as the limitation of the use band, for example, if a program recording and playback device that uses download service exists within the home network, its throughput is reduced.

When plural program recording and playback devices within the home network perform playback processing during downloading, even when the home gateway receives progressive down load start requests from the program recording and playback devices, if a band indicated by a use band contained in a band securing request cannot be secured, the home gateway transmits error information indicating that requested processing cannot be executed, to the program recording and playback devices that requested progressive download.

For a band securing request transmitted to the home gateway from the program recording and playback device, the header portion of a protocol such as HTTP and RTSP used for contents distribution is usually used. FIG. 4 shows a band securing request as described previously. A band securing request is transmitted using the extended header HTTP and RTSP. As a service identifier of the band securing request, ID for identifying streaming, download, and progressive download is set, and as a use band, the capacity of a communications band that be used in the home gateway is transmitted.

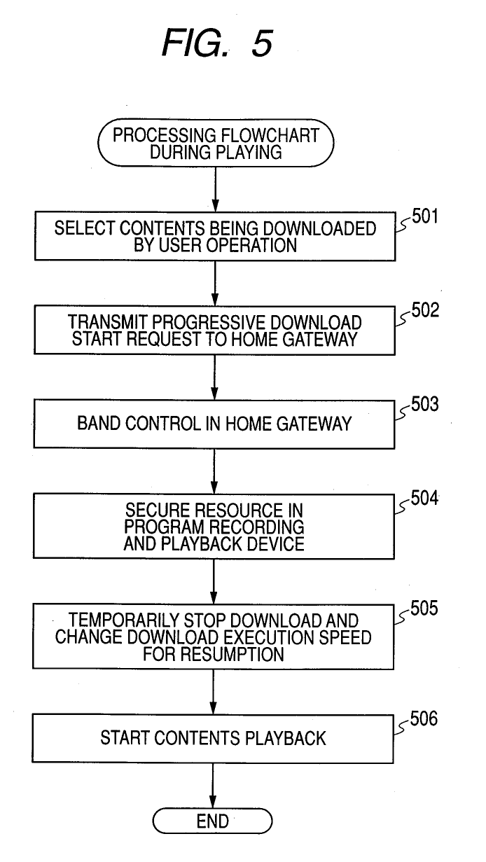

The following describes progressive download. FIG. 5 shows an example of a flowchart showing an overall flow of progressive download in the program recording and playback device 206.

A list of contents being downloaded are displayed on the display device connected to the program recording and playback device, and the contents being download that are to be played are selected from the list (Step 501). The contents being downloaded are contents initiated to be downloaded by user's selection from a distributable contents list acquired after connection to the distribution server by use of the HTML browser installed in the program recording and playback device.

Next, the program recording and playback device issues a band securing request of FIG. 4 to the home gateway to indicate that progressive download is initiated. The band securing request contains the service identifier of progressive download and the magnitude (bit rate) of a band used for it. The bit rate used is the same as the bit rate of the relevant contents or greater (Step 502).

Next, the home gateway performs band control so that the program recording and playback device secures a band requested by the band securing request (Step 503).

Next, the program recording and playback device manages resources (Step 504). On receiving information indicating that the band requested by the band securing request can be secured, from the home gateway, the program recording and playback device determines whether resources within it can be secured.

When resources within the program recording and playback device can be secured, it temporarily stops received streams of the contents being downloaded, and starts again downloading at a bit rate requested from the home gateway (Step 505). That is, it temporarily stops downloading to stop the session, and changes a download execution speed for resumption. Each router on the path preferentially transmit packets of the contents transmitted from the distribution server to the home gateway, based on set band control information.

When the downloading is normally initiated, the contents selected in the display device are played (Step 506). Although the downloading terminates when the contents have been downloaded to their end, the playback processing continues.

Thus, by performing progressive download with band control or the like, contents can be played to meet the information of the contents and network environments.

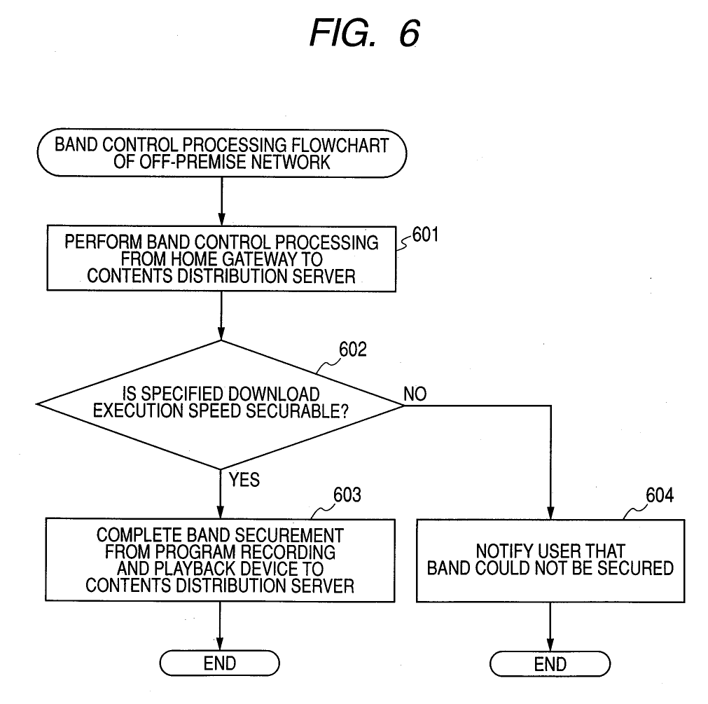

FIG. 6 is a drawing showing an example of a flowchart of band control processing in the home gateway of Step 503 of FIG. 5. When contents being downloaded are selected from the contents list being displayed in the display device, although a band securing request is transmitted from the program recording and playback device, when the home gateway has a function to enable band control from the distribution server to the home gateway, more stable progressive download is enabled.

The home gateway performs band control processing from the home gateway to the contents distribution server (Step 601). It initializes band control by using the function of the router between the distribution server and the home gateway.

Next, it determines whether the specified download execution speed can be secured (Step 602). For example, it uses a function such as SIP (Session Initiation Protocol) to secure band control when securing a session between the distribution server and the home gateway. If the specified download execution speed can be secured (Yes in Step 602), the processing proceeds to Step 603. If the specified download execution speed cannot be secured, the processing proceeds to Step 606.

In Step 603, the home gateway completes band securement from the program recording and playback device to the contents distribution server.

Step 604 is processing that notifies the user that it has been impossible to secure a band. The home gateway displays in the display device that a communication band cannot be secured, performs no production processing, and continues the downloading having been performed so far.

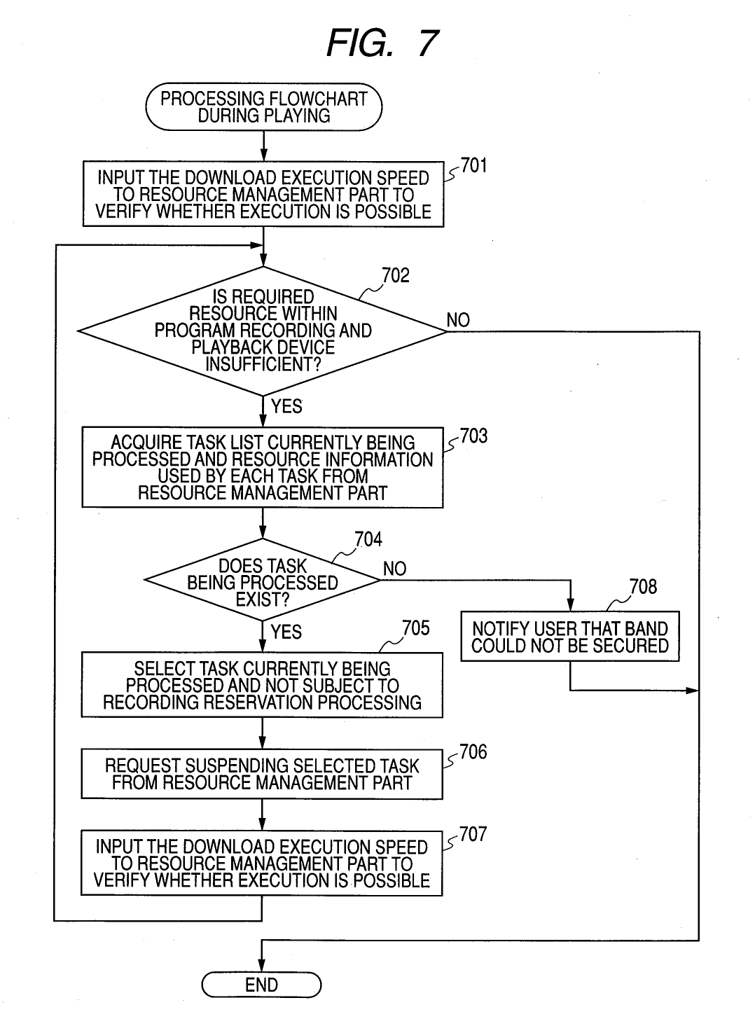

FIG. 7 is a drawing showing an example of a flowchart of processing of securing resources in the program recording and playback device of Step 504 of FIG. 5. The following describes an arbitration method when plural processings are performed in the program recording and playback device. The plural processings, which are managed by the resource management part, are performed when approval is given by the resource management part which checks the situations of the CPU, memory, and bus.

The program recording and playback device inputs a download execution speed (bit rate) necessary for progressive download to the resource management part to make a request to determine whether execution is possible (Step 701).

Next, the resource management part checks whether resources within the program recording and playback device are insufficient for the download execution speed inputted in Step 701 (Step 702). It determines whether downloading at the download execution speed inputted in Step 701 can be performed, from current processing situations within the program recording and playback device.

When resources within the program recording and playback device are insufficient. (Yes in Step 702), the program recording and playback device creates a list of tasks being currently processed within it and proceeds to Step 703. When required resources within the program recording and playback device are sufficient (No in Step 702), it terminates processing of securing resources, and proceeds to processing of playing contents.

In Step 703, the CPU acquires a task being currently processed and resource information (task list) used by each task from the resource management part. The acquired task list is expanded in the memory.

Step 704 determines whether a task in the process of stream processing exists, from a task list acquired by the CPU from the resource management part. When a task being processed exists (Yes in Step 704), the processing proceeds to Step 705. If there is no task in the process of stream processing (No in Step 704), the processing proceeds to Step 708.

Step 705 selects candidates to stop stream processing. In this step, tasks other than recording reservation processing for broadcasts are selected. Since the recordings of broadcasts cannot be performed later unlike downloading, they are removed from a list of candidates to stop stream processing.

Step 706 request the resource management part to suspend selected tasks. At this point, for example, a list to suspend stream processing contains tasks of lower priority such as VOD streaming, and download. In this case, streaming is determined to be in the process of being viewed by the users, and download is requested to suspend.

In Step 707, the resource management part determines whether download processing that is likely to execute stream processing can be executed when the download execution speed is inputted.

Step 708 notifies the user that resources could not be secured. When resources are insufficient, the register download processing is rejected, the display device is used to notify the user that the processing has not been performed, and the processing terminates.

Thus, by performing band control and resource management according to network environments and the like, contents distributed from a server can be stored and viewed more comfortably.

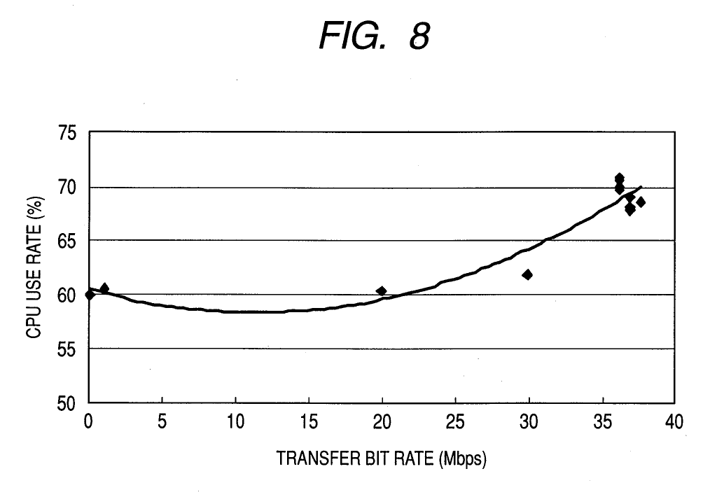

By narrowing transfer rates in a transmission side and controlling both throughputs in a reception side, processing loads on a receiver can be controlled and plural download processing can be controlled, so that concurrent operation with streaming is enabled. FIG. 8 shows the influence of a receiver in transfer rate control when control of a reception side is fixed.

FIG. 8 shows results of measuring CPU use rates of download processing in a receiver side when transfer bit rates of a distribution side are changed. For a CPU use rate of a waiting state 52.1%, a lower limit of about 60% is taken below 20 Mbps. This cause lies in the fact that a buffer of the receiver side was fixed to make a write to HDD in sequential processing.

### Second Embodiment

In a second embodiment, a description is made of not only a home gateway that can provide advanced services in a home network, but also a configuration that allows this embodiment to be realized even by a BB router generally used.

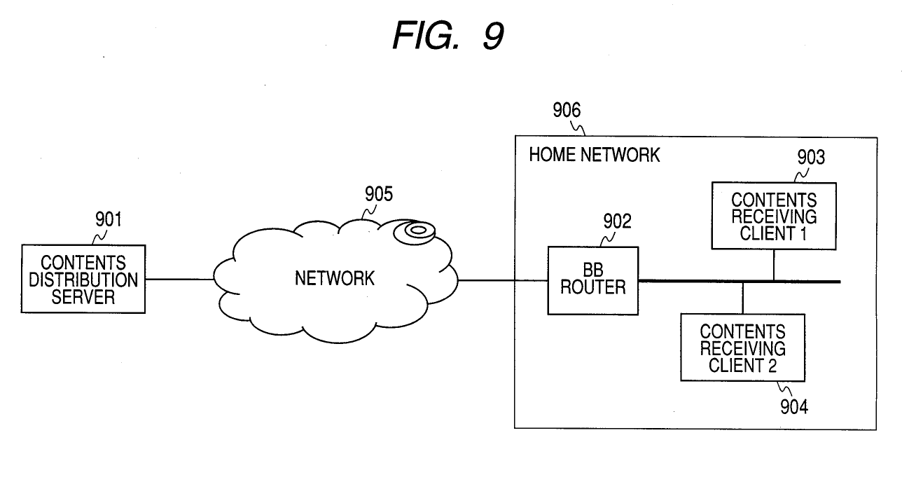

FIG. 9 is a system block diagram.

This is an example of a system configuration assume in the present invention.

In this drawing, the reference numeral 901 designates a contents distribution server; 902, broadband router; 903, content receiving client 1; 904, content receiving client 2; 905, network; and 906, home network.

The contents distribution server 901, which is connected with the network 905, stores contents such as videos, and distributes contents according to requests from clients connected via the network. The broadband router 902 is located in the boundary between a home network, and an external network (the Internet, etc.), and is connected with the network 905, the contents receiving client 1903, and the contents receiving client 2904. The contents receiving client 1903 and the contents receiving client 2904 are information processing devices that can store contents transmitted from the contents distribution server through the network in a data storage part of the contents receiving client, and play them. Generally, televisions, HDD recorders, and PCs that can receive VOD services correspond to them. The contents receiving clients can indicate states of each other to each other by communication means such as UPnP, and use services released by the contents receiving clients. Here, by managing the VOD service reception status of each other and mutually controlling the communication band of VOD service used in the contents receiving clients within the home network, progressive download environments can be provided to the user.

The hardware configuration of the contents receiving clients, which is shown in the program recording and playback device of FIG. 9, enables communication by UPnP through the LAN adaptor 905. Service descriptions 925 in which services provided by UPnP are defined are stored in the auxiliary storage part 908, and when the states of the contents receiving client are changed, and update information is sent to other contents receiving clients, the service descriptions 925 stored in an auxiliary storage part 908 are used to modify an update portion for transmission. The contents receiving clients exist in the home network and are connected with the broadband router 902, through which they can communicate with the contents distribution server 901.

The network 905, which is a broadband network such as the so-called Internet and CDN (Content Delivery Network), is connected with the contents distribution server 901 and the broadband router 902. The home network 906 is an on-premise network in which on-premise devices are connected by a wired LAN, a wireless LAN, and HUB. It includes information processing devices (not shown in the drawing) such as PC communicatable with the broadband router 902, the contents receiving client 1903, the contents receiving client 2904, and other devices.

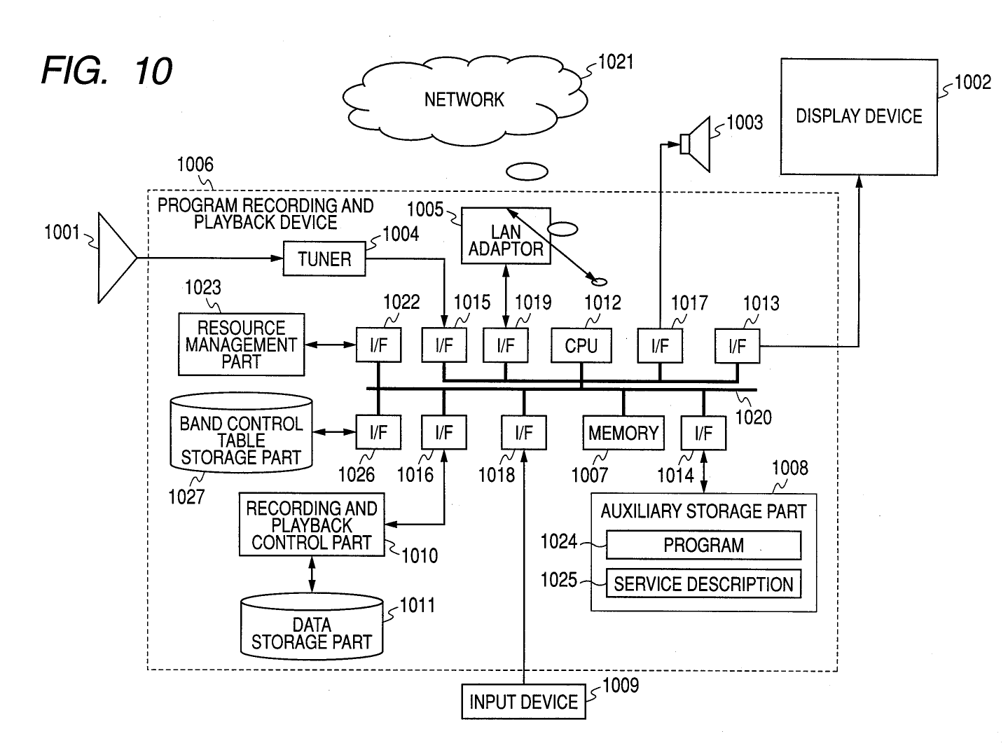

FIG. 10 is a drawing showing the program recording and playback device used in this embodiment.

In this drawing, the reference numeral 1001 designates an antenna; 1002, display device; 1003, loudspeaker; 1004, tuner; 1005, LAN adaptor; 1006, program recording and playback device; 1007, memory; 1008, auxiliary storage part; 1009, input device; 1010, recording and playback control part; 1011, data storage part; 1012, CPU; 1013, I/F; 1014, I/F; 1015, I/F; 1016, I/F; 1017, I/F; 1018, I/F; 1019, I/F; 1020, bus; 1021, network; 1022, I/F; 1023, resource management part; 1024, program; 1025, service description; 1026, I/F; and 1027, band control table storage part.

The antenna 1001 is a device that receives TV broadcasts such as terrestrial analog broadcast, terrestrial digital broadcast, or BS/CS digital broadcast, and is connected with the tuner 1004. The display device 1002 can output data streams flowing through the interface as video, and is connected with the I/F 1013.

The loudspeaker 1003 can output voice information specified by a program as voice, and is connected with the I/F 1017. The tuner 1004 selects a channel from a broadcast signal received in the antenna, and is connected with the I/F 1015 and the antenna 1001.

The LAN adaptor 1005 is a device that allows data transmission and reception to and from other devices by use of LAN (Local Area Network), and is connected with the network 1021 and the interface 1019.

The program recording and playback device 1006 includes tuner 1004, LAN adaptor 1005, memory 1007, auxiliary storage part 1008, recording and playback control part 1010, data storage part 1011, CPU 1012, I/F 1013, I/F 1014, I/F 1015, I/F 1016, I/F 1017, I/F 1018, I/F 1019, bus 1020, I/F 1022, resource management part 1023, and I/F 1026, and band control table storage part 1027.

The memory 1007 is RAM (Random Access Memory), which is a semiconductor to temporarily record programs and data. It is connected with the CPU 1012 and the I/F 1022.

The auxiliary storage part 1008 is a storage part for storing programs executed by the CPU, and is a nonvolatile storage medium such as ROM (Read Only Memory), SD card, compact flash (registered trademark), and HDD (Hard Disk Drive). It includes the program 1024 and the service description 1025, and is connected with the I/F 1014.

The input device 1009, which is connected with the I/F 1018, converts a user operation for controlling the program recording and playback device to an electrical signal, and transmits it to the program recording and playback device.

The recording and playback control part 1010 is an LSI that can control plural contents data transmitted from the tuner and the LAN adaptor, and contents data outputted to the display and the loudspeaker. It is connected with the data storage part 1011 and the I/F 1016.

The data storage part 1011 is a storage device such as incorporated IC memory or HDD (Hard Disk Drive) in which contents data acquired from the tuner and the network can be stored. It is connected with the recording and playback control part 1010.

The CPU 1012, which is a central processing unit for executing a program expanded in the memory, is connected with the memory 107, I/F 1013, I/F 1017, I/F 1014, I/F 1019, I/F 1015, I/F 1016, I/F 1018, and I/F 1026.

The I/F 1013 is an interface through which the display device can be controlled through the bus from other devices. The I/F 1014 is an interface through which the auxiliary storage part can be controlled through the bus from other devices. The I/F 1015 is an interface through which the tuner can be controlled through the bus from other devices. The I/F 1016 is an interface through which the recording and playback control part can be controlled through the bus from other devices. The I/F 1017 is an interface through which the loudspeaker can be controlled through the bus from other devices. The I/F 1018 is an interface through which an electrical signal transmitted from the input device can be received and transmitted to other devices through the bus. The I/F 1019 is an interface through which the LAN adaptor can be controlled through the bus from other devices. The bus 1020 is a communication path through which each device is connected via each interface to enable data transmission and reception. The network 1021 is a broadband network such as the Internet and CDN (Content Delivery Network), and is connected with the LAN adaptor 1005. The I/F 1022 is an interface through which the resource management part can be controlled through the bus from other devices.

The resource management part 1023 is an LSI or program that monitors bus capacity, CPU use rate, and memory capacity to determine whether broadcast recording, contents playback, VOD, and stream processing such as download recording can be performed. It is connected with the I/F 1022. The program 1024 is a program for registering UPnP service and band securing requests transmitted and received to and from other contents receiving clients in the band control table storage part. The service description 1025 is a UPnP service description file written in XML or the like. The program offers UPnP service to other contents receiving clients by using the service description. The I/F 1026 is an interface through which the band management table can be controlled through the bus from other devices.

The band control table storage part 1027 is a storage part in which a list of VOD services active in the contents receiving clients and network bands used in the individual VOD services are stored. It is a storage device such as an IC memory incorporated in the contents receiving clients or HDD (Hard Disk Drive), and is connected with the I/F 1026.

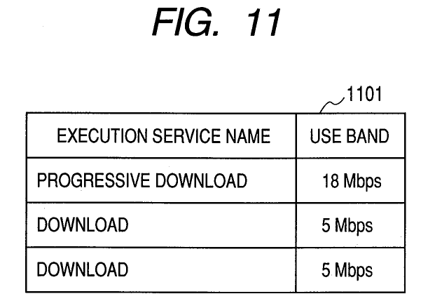

FIG. 11 is a drawing showing a band control table 1101. The band control table 1101 is table information stored in the band control table storage part within the contents receiving clients, and stores a list of VOD services executed in each contents receiving client within the home network and a list of bands used in each VOD service. The same information is registered in a table managed in each contents receiving client, and when VOD service is newly conducted, by evaluating the band control table 1101 of each contents receiving client and the use band of new VOD service, it is determined whether the service can be conducted. The evaluation refers to whether each contents receiving client manages a maximum communication band of the WAN side based on experience rules, or comparison between a maximum communication band of the WAN side acquired for a broadband router equipped with UPnP IGD (Internet Gateway Device), and a band necessary for new VOD service and a use band used in the band control table 1101.

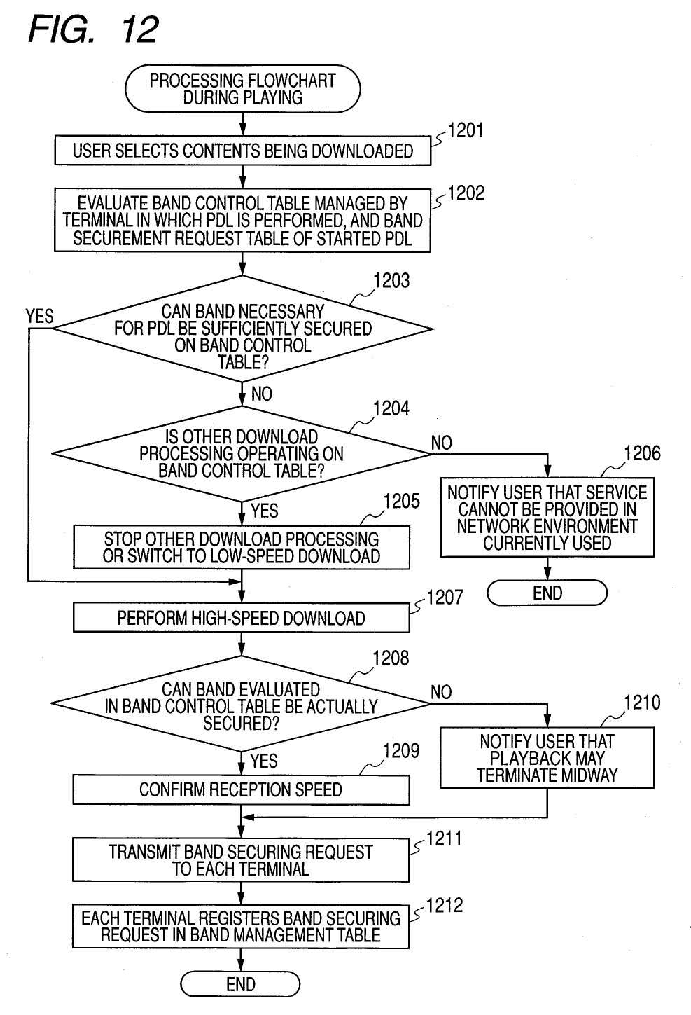

The following describes a processing flow of progressive downloading in this embodiment in FIG. 12.

In Step 1201, a user selects contents being downloaded. The user displays a list of contents being downloaded on a television screen, and selects a desired contents by remote control operation.

Step 1202 evaluates the band control table 1101 managed by a contents receiving client that is a terminal in which the progressive download is performed, and a band securing request table of the initiated progressive download. It compares the band control table 1101 in which VOD services processed by individual contents receiving clients are registered, and a maximum communication band acquired from experience rules of the WAN side or the broadband router, and evaluates whether a band possible with the progressive download remains.

Step 1203 determines whether a band necessary for the progressive download can be sufficiently secured on the band control table 1101, based on the result of Step 1202. When possible, the processing proceeds to Step 1207, and when impossible, the processing proceeds to Step 1204.

Step 1204 evaluates the band control table 1101 when each contents receiving client has used an almost maximum communication band to such an extent that the progressive download cannot be initiated in the present situation, and determines whether other download processing (including processing of other contents receiving clients) is operating.

Step 1205 halts other download processing or switches to low-speed download by halting download processing operating in a contents receiving client in which new service is registered, or download processing operating in other contents receiving clients, or issuing a request to switch to low-speed download. The halt or low-speed download refers to task priority control within the contents receiving clients described in the first embodiment.

Step 1206 notifies the user that new service (progressive download here) cannot be used because a sufficient band for conducting the service cannot be secured in a current home network environment for some reason in the home network environment currently used in Step 1204.

In Step 1207, as a result of evaluating the band control table 1101, since it is determined that fast download can be performed, a contents receiving client in which the progressive download processing is registered starts the fast download. As the fast download referred to here, besides a method of changing task priorities described in the first embodiment, a method of downloading contents regarded as targets in plural communication sessions is possible. The definition of the term fast refers to whether target contents can be fast forwarded in download throughput in the first embodiment.

Step 1208 determines whether a communication band actually required can be used as a result of performing fast download. Since it is difficult to surely grasp communication processings not performed in contents receiving clients that cannot be managed in the band control table 1101, results of actual measurements are evaluated.

Step 1209, as a result of performing fast download, confirms its real throughput, confirms its real throughput.

Step 1210 notifies the user that a throughput actually required cannot be secured in Step 1208, and the processing is continued as normal download processing.

In Step 1211, execution of new service (progressive download) is confirmed, and a band securing request 401 is transmitted to each contents receiving client.

Step 1212 registers the contents of the band securing request 401 transmitted to the band control table storage part 1027 of each contents receiving client. For off-premise communication band assurance, QoS control between the contents receiving clients and the contents distribution server may be performed in the timing of Step 1207 that starts fast download.

1. A contents distribution method of playing contents from a server in a terminal,
wherein the terminal transmits a request to start the playback of downloaded contents to a home gateway between the server and the terminal,
wherein the home gateway controls transmission bands between the server and the terminal according to the transmitted request, and
wherein the terminal secures resources of the terminal necessary for the download, changes an execution speed of the download, and plays the contents.

2. The contents distribution method according to claim 1,
wherein the request to play the contents contains information indicating a transmission band necessary to download the contents.

3. The contents distribution method according to claim 2,
wherein, in the control of transmission bands between the server and the terminal by the home gateway, if a transmission band indicated by information of a transmission band necessary to download the contents that is contained in the request to play the contents can be secured, the transmission band is secured, and if a transmission band indicated by information of a transmission band necessary to download the contents cannot be secured, information indicating that the transmission band cannot be secured is outputted.

4. The contents distribution method according to claim 1,
wherein the terminal stops a task processed in the terminal to secure a resource.

5. The contents distribution method according to claim 4,
wherein the task to be stopped is other than broadcast recording.

6. The contents distribution method according to claim 4,
wherein the task to be stopped is selected based on preset priority.

7. A receiving device comprising:
a receiving part that receives contents;
a storage part that stores contents received in the receiving part;
an output part that outputs contents received in the receiving part or contents stored in the storage part; and
a control part that, on receiving an indication to play contents being received in the receiving part, stops a task being processed.

8. The receiving device according to claim 7,
wherein the control part stops other than broadcast recording.

9. The receiving device according to claim 7,
wherein the control part selects a task to be stopped, based on preset priority.

10. A contents distribution method of playing contents from a server in a terminal,
wherein, when the terminal starts playing contents being downloaded, transmission bands used by individual terminals within a network are controlled, based on a transmission band necessary for contents playback, and
wherein the terminal secures a resource of the terminal necessary for the download, changes an execution speed of the download, and plays the contents.

11. The contents distribution method according to claim 10,
wherein a request to start playback of the contents contains information indicating a transmission band necessary to download the contents.

12. The contents distribution method according to claim 11,
wherein, in the control of transmission bands between the server and the terminal by the terminals, if a transmission band indicated by information of a transmission band necessary to download the contents that is contained in the request to play the contents can be secured, the transmission band is secured, and if a transmission band indicated by information of a transmission band necessary to download the contents cannot be secured, information indicating that the transmission band cannot be secured is outputted.

13. The receiving device according to claim 7, comprising: an identifier of reception processing that is operating at each terminal;
a storage part that stores a transmission band necessary for the reception processing; and
a receiving part that receives reception processing notification registered at each terminal through a network.
